(19) United States
(12) Patent Application Publication
(10) Pub. No.: US 2009/0076969 A1
(43) Pub. Date: Mar. 19, 2009

(54) System and method for deployment and financing of a security system

(76) Inventor: Collier Sparks, Helotes, TX (US)

Correspondence Address: George R. Schultz;Schultz & Associates, P.C., One Lincoln Centre, 5400 LBJ Freeway, Suite 1200, Dallas, TX, 75240, US

(21) Appl. No.: 12/150,472

(22) Filed: Apr. 28, 2008

Related U.S. Application Data
(63) Continuation-in-part of application No. 11/903,125, filed on Sep. 19, 2007.

(51) Int. Cl. G06Q 10/00

(52) U.S. Cl. 705/80; 705/9; 705/7

(57) ABSTRACT

A method is provided to itemize, install, finance and monitor a security system on a campus. A behavioral recognition training program for administration and staff is provided. A set of financing options is provided that minimizes or eliminates the burden placed on the school district for payment and maintenance of the security system. A computer system and network interconnects the campus to an application server and to a wide area network controller. The application server includes applications to implement the method including a site survey application, an engineering application, a financial assessment application, an inventory application, a project management application and a training application.

### RELATED APPLICATIONS

This application is a continuation-in-part of U.S. patent application Ser. No. 11/903,125 filed Sep. 19, 2007 entitled “System and Method for Deployment and Financing of a Security System”.

### COPYRIGHT NOTICE

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD OF THE INVENTION

The present invention relates to the deployment and financing of a comprehensive security program for a school campus. In particular, the invention is a method of implementation of a security program that provides a combination of physical security for school campuses, training of personnel and novel financing methods.

### BACKGROUND OF THE INVENTION

Our nation's education system contends with unprecedented security challenges today. Schools for all ages of children and in diverse geographic locations have become the backdrops of horrific violence. Never before have children faced such danger in places such as schools.

In response to the security challenges faced by schools, many state and local governments have implemented security audit procedures and security requirements for schools. Examples are Texas Senate Bill 9, S.B. 9 80(R) (Tx. 2007) and Texas Senate Bill 11, S.B. 11 80(R) (Tx. 2007), passed by the Texas Legislature in 2007. These bills, and others like them, require schools to conduct a security audit to locate vulnerabilities to students, faculty and school campuses.

Unfortunately, at the same time as security requirements are increasing, school budgets are decreasing. Generally schools are faced with higher student loads, increased educational demands, increased employee expenses and increased equipment costs to administer and carry out their educational functions. Many times these increasing financial pressures severely limit or prevent the installation of expensive access control systems and the employment of trained security personnel which are required to implement an effective security system in a school.

Prior art security systems for a school typically include the access control system such as video cameras and sensors, card readers, badges and portals, the software and computer network that provides database storage and data communication and importantly the personnel to provide the physical security of the building and the people in it. Typically, each school district is responsible for the purchase, administration and maintenance of the security system. Additionally, a school district typically provides non-educational administrative services. Examples are employee health insurance and benefits, employee payroll, student transportation, facility maintenance, and cafeteria services. Each school district duplicates many of the same administrative functions creating redundancy and overlap. Overlap of redundant administrative operations create inefficiencies. The inefficiencies are expensive and reduce the ability of each of the school district to provide other education related functions and to provide security systems.

### SUMMARY OF THE INVENTION

The present invention provides a system and method to implement and fund a security system in a school district which can be customized to meet the demographics, behavioral dynamics and threat level of each school system and that meets the requirements of federal, state and local laws. The invention includes a method designed to minimize the risk of violence and misconduct in a school district by analyzing the needs of the school district and supplying a security system through outsourcing of various non-teaching related administrative tasks of the school district and centralizing them with a single security system provider realizing a savings. The savings is used to fund and support the security system.

Accordingly, an embodiment of the present invention provides a method for the deployment of a security system for school districts. A “security system” includes an access control system, a supporting computer network and security personnel such as IT support and security guards. The method includes conducting a site survey where the physical layout of a school and the current level of security is assessed. The site survey also includes an audit of scalable administrative functions. The site survey further includes a risk assessment where the vulnerabilities of the existing physical security system are studied. Funding options are evaluated. Notably, among the funding options is the outsourcing of the scalable administrative functions to a security system provider. A deployment contract is negotiated including an identification of the components of the access control system, security personnel and scalable administrative functions to be outsourced. After contract closing, a set of engineering and installation teams are identified. Security background checks of all members of the engineering and installation teams are performed. A database of acceptable engineers and installers is created.

The engineering team itemizes equipment and identifies appropriate prepackaged design modules. Required custom designs are identified. The design modules are palletized and prepared for shipping. Shipment is coordinated with other shipping requirements to minimize cost.

The installation team is deployed. The installation team unpacks and verifies the design modules and installs the access control system. Network communication is verified. All school faculty, employees and students undergo a citizenship check, a social security check, a motor vehicle report, a credit report, and are fingerprinted. This is done in order to create a personal file, associated data base and an ID badge. The badging process includes the steps of photographing the staff, students, and the parents. A visitor control system creates temporary ID badges as needed for parents and visitors.

School employees are trained to use all the features of the newly installed hardware and software systems. Faculty and administration undergo behavioral anomaly recognition training from trained criminal and behavioral psychologists. Administrators and faculty are taught how to recognize potentially dangerous individuals, locations and situations in an effort to prevent security breaches from occurring.

The method includes computer network monitoring of the access control system by the security system provider. The method further includes the assumption of the scalable administrative functions of the school district and combining them with other similar tasks from several school districts to realize a savings in money and time through consolidation. The savings in money spent by the school district is used to implement the security system or to reduce its cost to the school district. System maintenance and upgrades are performed on a predetermined schedule or on an as needed basis.

Those skilled in the art will appreciate the features and advantages of the invention together with other important aspects upon reading the detailed description that follows in conjunction with the figures provided.

### BRIEF DESCRIPTION OF THE DRAWINGS

FIG. 1 is a schematic drawing of a computerized campus security system with an access control system as is known in the prior art.

FIG. 2 is a schematic drawing of a computer networked system for assessment, deployment, and operations of a security system connecting one or more campuses with access control systems.

FIG. 3 is a flow diagram of the process for assessment, engineering, deployment and operations of a security system in the preferred embodiment of the present invention.

FIG. 4 is a flow diagram of the steps for conducting a site survey and generating a site survey report.

FIG. 6 is a flow diagram of the initial engineering process for security engineering and system design.

FIG. 5 is a flow diagram of the steps for contract negotiation and closing.

FIG. 7 is a flow diagram of the final engineering process for security engineering and system design.

FIG. 8 is a flow diagram of the steps for coordinating system assembly and shipment.

FIG. 9 is a flow diagram of the steps for installing the components of the access control system.

FIG. 10 is a flow diagram of the steps for implementing staff and student badging.

### DETAILED DESCRIPTION OF THE PREFERRED EMBODIMENT

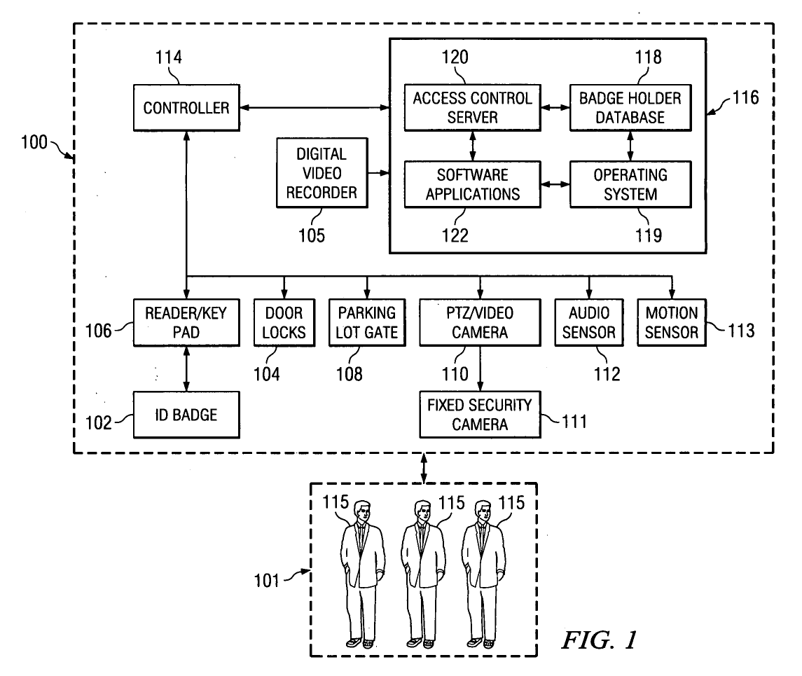

Embodiments of the present invention and its advantages are best understood by referring to FIGS. 1 through 9, like numerals being used for like and corresponding parts of the various drawings.

A schematic of the typical components of a prior art security system are shown in FIG. 1. The security system includes computerized access control system 100 and a set of security personnel 101. Access control system 100 includes a computer system 116. The computer system is housed in a physically secure location and monitored for tampering. Computer system 116 comprises a server including a badge holder database 118, software applications 122, operating system 119 access control server 120 and digital video recorder 105. Badge holder database 118 includes a set of records storing fields identifying information related to various authenticated and unauthenticated cardholders such as PIN numbers, fingerprint data, and encryption passwords. Software applications 122 run in the operating system environment and comprise executable files necessary to access the badge holder database 118, initiate network communication and run various applications necessary to the functioning of the access control system. Badge holder database 118 and software applications 122 are held in data communication with access control server 120. Access control server 120 is a hardware and software system which allows network communication with controller 114. Controller 114 also communicates information to and receives information from reader/key pad 106, door locks 104, parking lot gate 108, PTZ video camera 110, fixed security camera 111, audio sensor 112, and motion sensor 113. Reader/key pad 106 communicates user information read from an ID badge 102 and user entered information to controller 114 which operates the door locks 104 and parking lot gate 108 to admit or deny access. Information gathered from video camera 110, audio sensor 112, and motion sensor 113 is communicated through controller 114 and stored in computer system 116. An example of an access control system is the Safenet® System provided by MDI, Inc. of San Antonio, Tex.

Set of security personnel 101 typically includes personnel 115 to install and maintain the access control system 100 and also to provide physical security such as security guards and parking attendants.

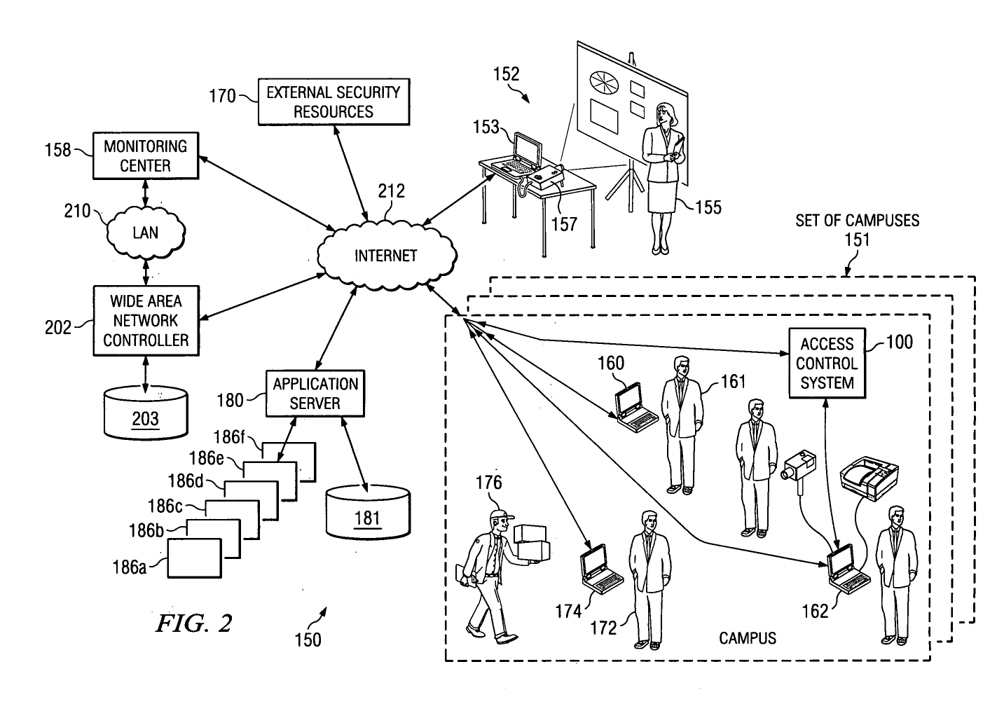

FIG. 2 shows a computer network 150 for organizing the security assessment, sales and engineering, installation and deployment, and operational phases of a security system. The computer network 150 comprises an application server 180 connected through the internet 212 to a set of campuses 151 and a meeting room 152, application server 180 having a project data repository 181 and a set of support applications including: site survey application 186a, engineering application 186b, financial assessment application 186c, inventory application 186d, project management application 186e and training application 186f. Each campus has at least one physical access control system 100 which together form a set of access control systems connected through the internet 212 to wide area network controller 202. Data contained in the set of access control systems, such as the badge holder database 118 of FIG. 1, is backed up in global access data repository 203 connected to wide area network controller 202. A monitoring center 158 connects to the wide area network controller 202 through a local area network 210 for security monitoring operations. The monitoring center 158 may also connect to access control system 100 directly through the internet. A set of external security resources 170 including law enforcement agency web servers connected to the internet 212, the set of security resources 170 used by the computer network 150 during deployment and operations. Set of campuses 151 may be in geographically distinct locations, and for example, may be a set of educational, government, or corporate campuses.

During the security assessment phase, assessment computer 160 may be placed on a campus site by personnel 161 to perform a site survey, wherein the information may be entered and stored by site survey application 186a running on the application server 180. During the sales and engineering phase, a presentation computer 153 with a projection system 157 may be placed in meeting room 152 and operated by personnel 155. Presentation computer 153 and projection system 157 are connected to application server 180 by internet 212 and used to communicate pre-engineering and final engineering information stored by engineering application 186b on application server 180 to verify delivered security modules 176. Financial assessment application 186c is also used during the sales and engineering phase to determine project costs and financial projection and may be as simple as a spreadsheet program on which various costs and funding options are calculated and reports derived therefrom. During the installation phase, an inventory computer 174 may be placed on a campus site by project personnel 172, the inventory computer 174 connected by internet 212 to project management application 186e running on application server 180. During the deployment phase, badging system 162 may be placed on a campus. Badging system 162 is communicatively connected to wide area network controller 202, to the campus access control system 100 and to external security resources 170. The installation and deployment phase is managed by project management application 186e to insure that the security system is deployed completely and correctly. During the operations phase, the monitoring center 158 is connected by internet 212 to the set of access control systems 100.

Each access control system 100 includes a network controller capable of communicating access control information to wide area network controller 202. As is known in the art, data communication occurs through TCP/IP protocol and may include data packets, streaming video data, audio data or systems operation data such as override commands to door locks and positioning and pre-shot locations for PTZ video camera positioning devices. In a system as shown in FIG. 2, various functions of monitoring and controlling the access control systems 100 are carried out by the wide area network controller 202.

In the embodiment described in the remainder of this description, the set of campuses 151 will be considered to be a school campus and the illustrations and examples will apply to a school campus environment. The invention is not intended to be limited by the school campus embodiment and may be applied to business or government oriented campuses.

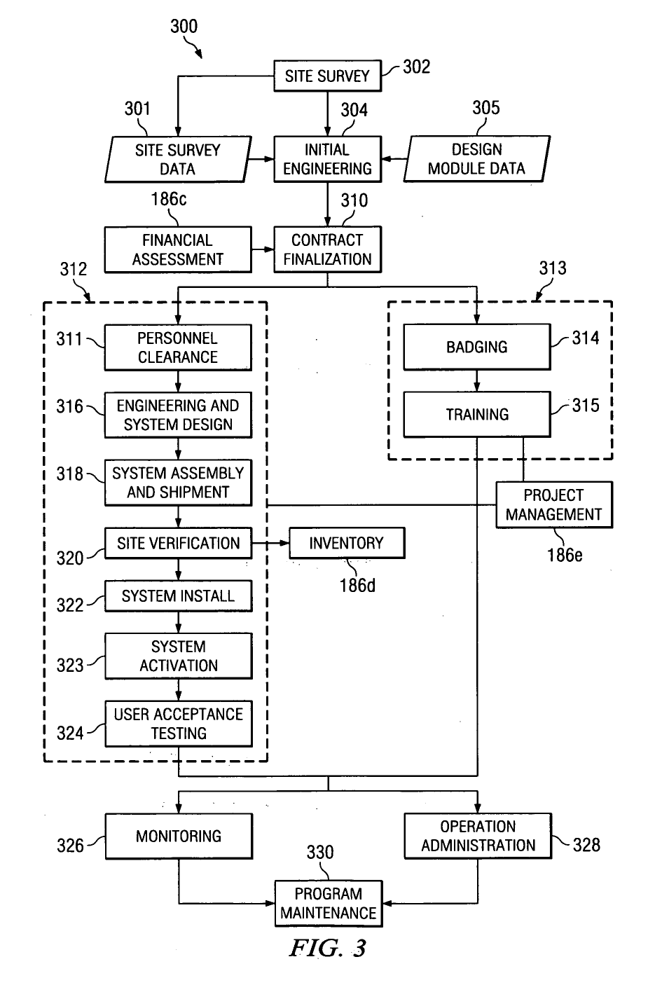

Referring now to FIG. 3, an operational flow chart is shown of a preferred method for the deployment of a security system for school campuses. Various steps of the method will be further described later in reference to more detailed figures. Method 300 begins with site survey step 302. Site survey step 302 entails an observation of the existing physical buildings and security system provided by the school district and an audit of scalable administrative functions. A risk assessment is performed to determine the security vulnerabilities of the school campus from the site survey step 302. Site survey data 301 captured from the site survey step 302 is stored in data repository 181. Initial engineering process 304 utilizes site survey data 301 and preexisting design module data 305 from data repository 181 to analyze the equipment needs and cost of the security system and to communicate the results to the administration of the school district. Available funding options are examined in the contract finalization step 310 and a contract is negotiated and executed between the security system provider and the school district.

A physical implementation project 312 to fully engineer, install and deploy the security system is initiated and tracked in project management system 186e. Similarly, a group implementation project 313 to prepare the school personnel and students for the security system is initiated and tracked by project management system 186e.

Physical implementation project 312 begins with personnel clearance in step 311, wherein each member of the engineering design team and the installation team are identified. Furthermore, a detailed background check of each engineering and installation team member, employee, contractor and vendor is undertaken with respect to citizenship, work history and criminal record. Unfit candidates are replaced and their identities logged into a database. Also in step 311, ID badges for approved engineers and installation team personnel are created and catalogued. A database of approved personnel is also created.

The engineering team performs engineering and system design in step 316 which results in the specification of a bill of materials for a set of design modules. In step 318 the design modules are palletized and shipped to each school campus site. As the shipment reaches each site, the pallet contents are verified against the design plan and logged into inventory application 186d in step 320. The equipment and access control software is then installed in step 322. After the equipment and software is installed for each site, security system activation occurs in step 323, after which user acceptance and testing occurs in step 324.

At the time of system installation, group implementation project 313 starts by badging the students and school employees in badging step 314. In training step 315 administrators and teaching staff are trained on how to recognize and ideally prevent potential security breaches before they occur. In this step, school employees are also trained in operation of security system hardware and software. During training step 315, the security system is activated and monitoring 326 begins. At step 328, outsourcing of the operational administration tasks identified in an administrative audit in site survey 302 takes place to the security system provider.

An alternate embodiment includes program maintenance step 330. In this step, the security system provider returns to the school campus at predetermined intervals to assess the state of the security system, train recently hired faculty, and install additional security equipment or upgrades.

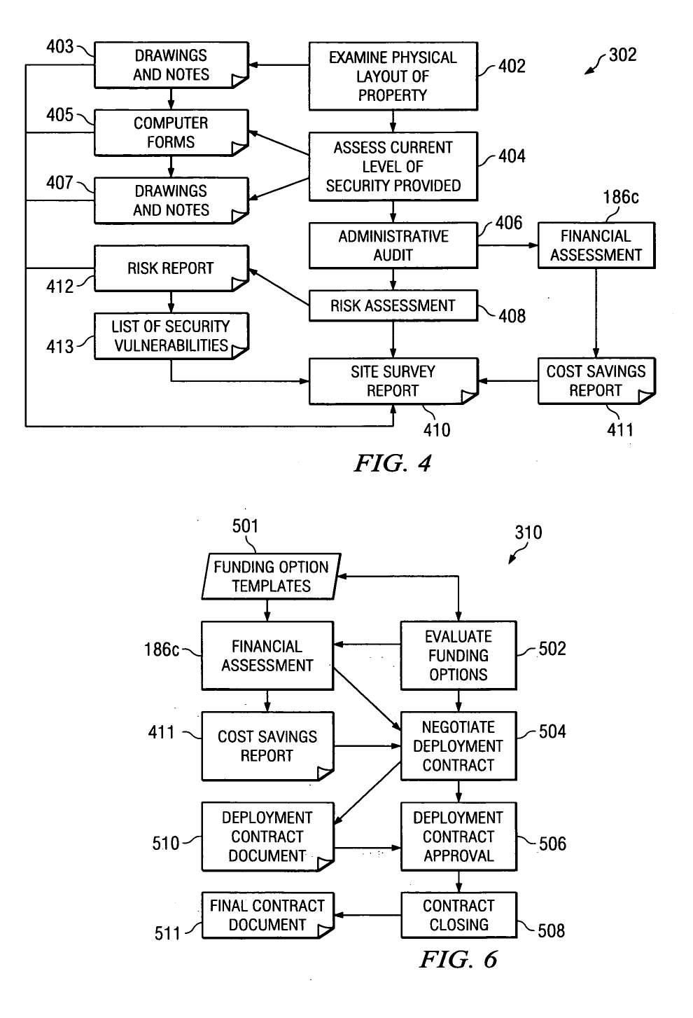

FIG. 4 shows further details of site survey step 302 of FIG. 3. In step 402, the physical layout of the campus is examined. An analysis of the physical structures themselves and the arrangement of those physical structures on the campus is performed and cataloged in a set of drawings and notes 403. Parking lot locations and passageways to and from the parking lots and the buildings are noted. Power supply points and structural versus functional supports are identified. Outer perimeter geographical features related to security are analyzed. Examples are large bodies of water, dams, mountainous terrain and proximity to nuclear strike targets such as large cities and governmental centers. Outer perimeter traffic studies are performed including traffic volume and flow patterns. A typical vehicle profile is also developed so that statistical outliers may be identified automatically. External and internal access points are identified. Student and faculty traffic patterns and volumes are identified. A typical student profile is developed. A typical faculty profile is developed. Bottlenecks to student and vehicle traffic and confusion points are identified. Problem groups both internal and external are identified such as gangs and registered sex offenders. Building vulnerabilities to blast destruction and vehicle intrusion through ramming and explosive ordinates are analyzed and cataloged in drawings and notes 403 together with the other data from step 402.

In step 404, the existing level of security provided is assessed. Student surveys are taken as to the attitudes of students and parents toward security measures and video surveillance. Objective measures of security problems at the school are derived from the surveys or from existing administrative records. In the preferred embodiment, an “incident per time” measure is taken. Arrests per month, office referrals per day and “break-ins” per year are examples used in the preferred embodiment. The objective measures are used as benchmarks for comparison to determine the “success” of the security system and for school district profiling, as will be further described. The information is collected in a set of computer forms 405 including surveys filled out by the school employees and students and information data sheets filled out by assessment advisors.

An IT audit is conducted to determine the capabilities of the existing IT infrastructure. Existing video surveillance systems, guard stations, perimeter fencing, lighting, and access point locking characteristics are all identified and cataloged in drawings and notes 407.

An administrative audit is performed next at step 406. In this step, non-teaching administrative functions of the school district are analyzed for functions which may be operating inefficiently and can be successfully scaled by outsourcing. Non-educational services such as building maintenance, student transportation services, cafeteria services, and human resources functions including payroll, health benefits and insurance administration are investigated in an attempt to recognize inefficiencies. Inefficiencies such as improper training of administrators, antiquated computer systems, payroll anomalies (such as excessive overtime, excessive vacation or sick leave, and improper task grouping) are examined. As a funding option to be described later, the preferred embodiment of the method includes outsourcing the inefficient services to the security provider at each campus. The security provider combines the inefficient services with those like services carried out for other school districts. The security provider uses state of the art equipment, specialized employees and streamlined task flow methods to provide the services to produce a cost per transaction reduction. The outsourcing of services allows for more efficient administration and a cost savings realized. The cost savings realized is used to fund the implementation of the security system. To assess the cost savings financial assessment application 186c is used to generate a cost savings report 411.

In step 408, a risk assessment is performed. “Risk” in this disclosure is the risk associated with breach of the security system. In this step an analysis of the security vulnerabilities of a school environment and the weaknesses in building security is undertaken. Locks, windows, doors, fences, gates and buildings as well as all access portals and passenger and vehicle traffic flow are examined for security vulnerabilities. Vulnerabilities as to unauthorized access to traffic, parking, student, faculty and digital and analog communications are scrutinized. In some cases, a security breach test is conducted whereby a third party expert is hired to attempt to breach the access control system, the perimeter fencing traffic access or data integrity. Results of the security breach test are analyzed for reliability. The risk assessment is reduced to writing in a risk assessment report 412 which includes a list of security vulnerabilities 413 with suggestions for mitigating those vulnerabilities.

In step 410, a site survey report is created. The site survey report 410 categorizes the existing physical layout of the campus and the list of security vulnerabilities 413. The report also describes the existing level of security equipment, and includes the risk assessment report 412. The site survey report 410 also identifies potential administrative functions for outsourcing.

Initial engineering process 304 is shown in the flowchart of FIG. 5 wherein the security system is engineered based on data in site survey report 410. In step 602, the list of security vulnerabilities contained in the site survey report 410 is used along with the physical layout of the school to select locations 603 for security system components. The selected locations 603 are compared in step 604 to a preexisting location type table 601 contained in data repository 181, which lists for a given location type the categories and average quantities of security equipment (such as cameras and door badge readers) that are required for an average access control system. From the comparison, a listing of design modules 606 is derived that includes the minimum equipment required for implementation of the access control system. Locations requiring custom design are listed in step 608. In step 610, the listing of design modules 606 and custom designs 608 are incorporated into a computer model 610, the custom designs being estimated in size and components. The output of the computer model is captured as an estimated bill of materials 612 including the estimated system cost. The bill of materials 612 is stored in the data repository 181 for use in the contract finalization.

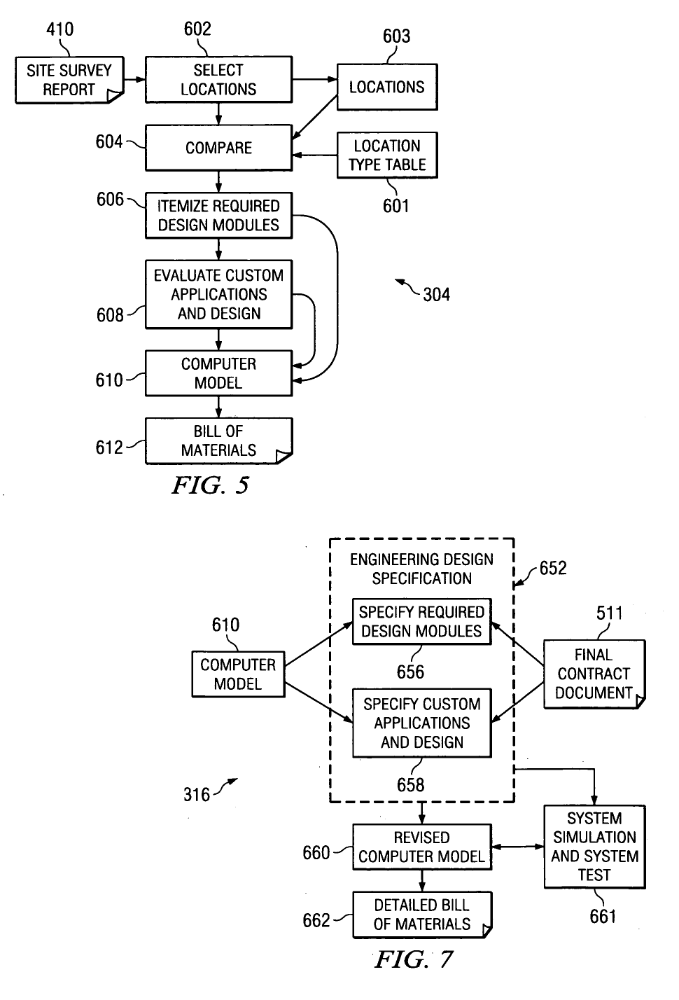

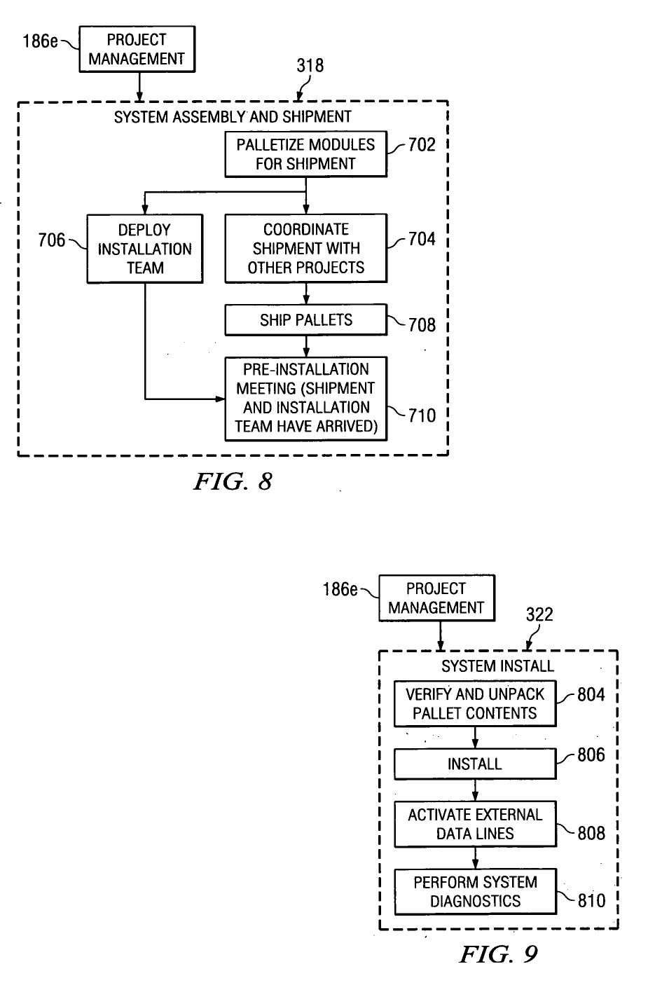

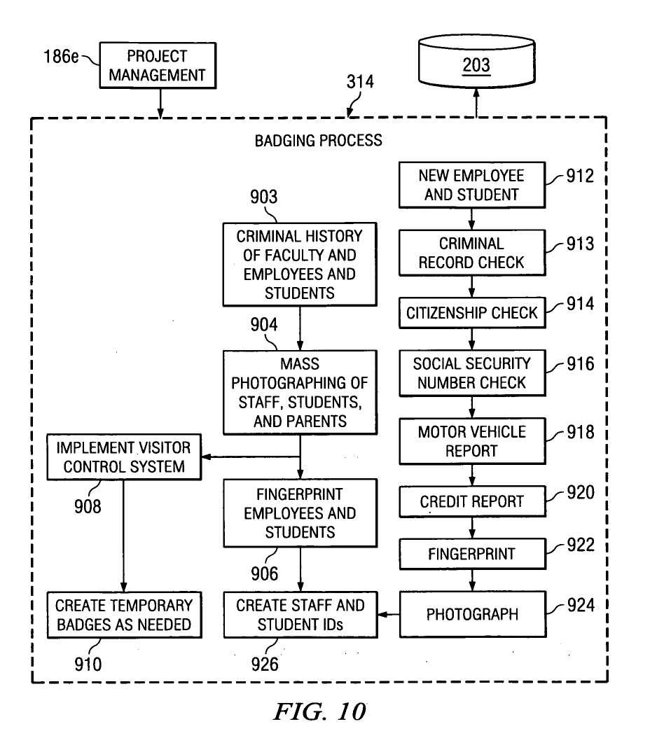

The substeps of the contract finalization step 310 from FIG. 3 are shown in reference to FIG. 6. The first step is to evaluate funding options 502. In this step, a set of available financial mechanisms described by a set of funding option templates 501 are evaluated for their applicability and availability to pay for the implementation of the security system. The set of funding option templates 501 are stored in data repository 181 and available to financial assessment application 186c.

One funding option included in templates 501 is participation by the school district in the outsourcing of non-educational administrative services. For example, the “scalable” services are services that may become more efficient by combining similar tasks and completing them by a dedicated set of personnel and equipment. Scalable administrative tasks which are outsourced to a single provider realize a cost savings. Payroll and administration of benefits plans are typically “scalable”. Continuing the example, it may currently cost a school district $600 per employee per year to collect and record time cards and print and distribute paychecks. An outsourced solution may be able to provide the same services for an estimated $100 per employee per year. As the outsourced solution scales to include multiple districts, the cost per employee will be further reduced. The result is a $500 savings per employee per year for the school district. The combined savings from administration of payroll for all employees of the school district, assuming the school district has 1000 employees is $500,000. Of this $500,000 savings the school district can afford to pay $100,000 for an access control system for a school. The remainder of the savings can be used for other purposes including financing of the remainder of the security system. Typical scalable administrative services include building maintenance, cafeteria services, security personnel, grounds keeping services, transportation services, insurance administration and payroll administration.

Another funding option in templates 501 utilizes the good will of local businesses to establish public or private sponsorships. In exchange for funding the security system, local businesses are offered an opportunity to advertise their involvement with the security of the school. Additionally, the sponsoring business may be provided advertising space on security badges and video portals. The reputation of a safe and secure school system will drive new residents and potential customers to the area and to local businesses.

Other funding options that may be included in templates 501 include federal, state or private grants. Up to 90% of the deployment cost of the security system may be funded by grants. An example is the United States government's “E-rate” program, which provides grants to fund telephone, Internet and IT infrastructure projects for schools and libraries.

Other funding options that may be included in templates 501 include leasing the access control system to the school. In this option, the security provider owns, maintains, monitors and updates the access control system greatly reducing the cost burden on the school district.

Still other funding options included in templates 501 include financing the purchase of the access control system by the security system provider to allow extended payment to the school district over a fixed or extendable term.

Financial assessment application 186c is utilized to choose and combine a set of funding options for the school district and further evaluate those funding options with the savings included in the cost savings report 411. Once a funding option or a combination of options is chosen, negotiate deployment contract step 504 follows. In step 504, the final cost of the implementation is calculated and negotiated. In this step, cost factors such as the description of the access control system, the number of required security personnel, the non-educational administrative services to be outsourced and the lease or length of the payout period are considered. For example, a school district having a larger campus will require larger and more complicated access control systems and more security guards than a smaller campus. Larger access control systems affect cost. As another example, a school district that outsources more non-educational administrative services than another will realize more cost savings and be able to pay for the security system sooner, but will have higher monthly contract costs. Higher monthly contract costs are offset by the additional savings that school district will realize by outsourcing a greater number of scalable administrative services. The financial assessment application 186c is further used to fine tune the final deployment contract during negotiations. Also, the initial engineering step 304 may be iteratively performed to fine tune the implementation and the costs considered in the final deployment contract.

The deployment contract specifies the access control equipment to be installed, the designation of the security personnel to be provided, the maintenance schedule for the access control system, the scalable administrative systems to be outsourced and the training to be supplied by the security personnel. The deployment contract also identifies the payment schedule to the security provider and for the ownership of the access control system. The contract also identifies when system upgrades are performed and how the cost of any upgrades is addressed. Those skilled in the art will recognize that other contractual provisions can be included to specify the relationship between the security provider and the school district. The result of step 504 is a deployment contract document 510.

Deployment contract approval step 506 follows. In this step, the deployment contract is presented to the required school boards and trustees for approval. Approval requirements in various school districts may differ.

Contract closing step 508 follows. In this step, a contract closing is held and the school district formally undertakes to implement the security system. Signed and approved versions of the final contract document 511 are stored in data repository 181 and form the basis for final engineering and deployment.

The substeps of the engineering and system design step 316 from FIG. 3 are further described in reference to FIG. 7. Engineering design specification 652 and detailed bill of materials 662 for the access control system are created using the methods of the engineering process 304 but with the design modules 656 and custom designs 658 being derived from the pre-contract computer model 610 and final contract document 511. The detailed bill of materials 662 includes specific design modules which themselves include computer hardware, video hardware, access control hardware and connecting wiring or wireless network equipment. The software includes operating system software, network communication software and access control software, including software to carry out the functions of the access control system. For example, artificially intelligent software capable of recognizing congregation patterns and traffic flow anomalies software is provided. Another example is software capable of a logging of statistically outlying vehicles, students and personnel. The preferred embodiment utilizes artificial intelligence technology known as the LineUp, CamSmartz, and CarDetector products available from Vigilant Video (http://www.vigilantvideo.com/products.htm). As the artificial intelligence technology in the preferred embodiment includes human face recognition, moving and stationary objects recognition, and license plate recognition.

The design modules specified in step 656 are groups of related access control equipment that are packaged together in standardized numbers to facilitate handling and shipment. By way of further explanation, school campuses have many elements in common. For example, they each have classrooms, computer rooms, cafeterias, kitchens, etc. There are hallways and passageways leading between the rooms and buildings. There are typically gymnasiums and parking areas. The similar elements allow a large degree of standardization in the supply of access control and video monitoring equipment. For example, a typical sized classroom requires a pre-measured and precut length of wires, a certain number of cameras, a specific number of audio sensors, and a certain number of door locks and card readers. A packaged module containing the equipment of a typical classroom is wrapped together in color coded cellophane and is therefore easily recognizable as a classroom module. As an example, a camera group module in the preferred embodiment includes a five (5) classroom group of ten (10) cameras with 50 feet of CAT IV cable per camera and five (5) signal buffer modules. This standardization allows implementation of a modular design philosophy. The modular designs can be effectively palletized for shipment and use. Modules can be stocked according to a color scheme, a lettering scheme, or RFID identification system. School sites can then be categorized quickly by use of the module codes instead of a detailed equipment specification as in the prior art. Speed of deployment is increased. Storing efficiency is increased.

The following table shows a set of group units in a preferred embodiment:

| | | Modular |
|---|---|---|
| Group Module Name | Group Module contents | Color Code |
| Camera Block | 5 color CCD Cameras | Blue |
| Module | 5-35 mm lenses | |
| | 5 TCP/IP communication cards | |
| | 50 FT. CAT IV cable | |
| | 5 signal buffers | |
| Server Conductor | 200 Mhz server | Orange |
| Block Module | backup tape drive | |
| | backup battery pack | |
| | installation pack | |
| | 50 position router switch | |
| | software bundle | |
| Parking Lot Block | 12 floodlight stacks | Yellow |
| 100,000 Sq. ft. | 12 floodlight mount kits | |
| Module | 4 mount hardware kit | |
| | 4-360 quad camera pods | |
| | power supply | |
| | wireless router | |

The types and numbers of modules are documented. In a preferred embodiment, all equipment in each module is tested to assure proper operation before packaging.

If a particular deployment requires additional security equipment not found in the set of design modules, a custom module is specified in step 658. Then a revised computer model of step 660 is executed in step 661 to perform system simulation and system test. In this step, load testing and scalability testing are completed as known in the art. Load testing and scalability testing tools such as those offered by HyPerformix, Inc. of Austin, Tex. are suitable. Completion of engineering and system design step 316 results in detailed bill of materials 662 that be can be purchased and assembled into design and custom modules.

The system assembly and shipment process of step 318 of FIG. 3 is shown in relation to FIG. 8. All the tasks of step 318 are tracked and coordinated by project management application 186e. The required modules of the security system are palletized for shipment in task 702. At task 704, the shipment is coordinated with other projects. Loading the palletized modules of several security system deployment locations on one vehicle if the locations are close in proximity reduces shipping costs.

The installation team is deployed to the job site at task 706. The access control system is shipped from the warehouse in task 708. At task 710, the access control system arrives at the site destination as does the installation team. A preinstall meeting is held to confirm presence of the installation team and the shipment. In another preferred embodiment the installation team is segregated into sub-teams of differing sub-specialties. The arrival of these sub-specialty groups at the job site is staggered according to the project management application 186e to match an estimated benchmark schedule for implementation of the access control system.

FIG. 9 shows the process involved in system install step 322 from FIG. 3 including a series of tasks that are tracked and coordinated by project management application 186e. At task 804, the installation team verifies and unpacks the pallet contents 804 to ensure proper delivery of all required modules. At task 806, the installation team installs the access control system according to the installation plan. Integration of the existing security equipment at the school with the access control system is accomplished at this step. All access control equipment such as cameras, PTZ controllers, digital video recorders, tape backup systems, audio sensors, motion detectors, electronic door locks and the cables required to power the equipment and transmit their signals are installed. Software is installed. At task 808, external data lines for communication with the Internet are activated. All computer network equipment is checked for function and proper communication with the external data lines. At task 810, system diagnostics and tests are performed. All equipment is checked to see if it is properly connected and in proper working order. Data transmission to the wide area network controller is also verified.

FIG. 10 shows the substeps involved in badging step 314 from FIG. 3. ID badges are required to gain access to physical locations. The badges can also be time locked to allow entry only during certain times. The badges may be magnetic strip cards or may be Radio Frequency Identification (RFID) tags capable of being detected by proximity readers. Of course, other formats of data carriers, such as smart cards containing flash memory will suffice. The ID badges are also linked to a database containing medical history of the student and familial relationships and contact numbers. At step 903, an optional criminal record check of faculty, employee and students is completed using external security resources 170 of FIG. 2. If consent is required it is obtained in this step. At step 904, the mass photographing of staff, students, and in some cases, parents is performed. The photos of the parents are stored in a database. At step 908, a visitor control system is implemented which sets up a database and creates temporary badges as needed. At step 910, temporary visitor badges complete with photos stored in the database are printed on an as needed basis. At step 906, employees and students are fingerprinted. A digital image of the employee's or student's fingerprint and photograph are stored in a database and used as verification as needed. The last step in badging step 314 is to make the staff and student ID badges at step 926. An ID badge is created for every student, every teacher, every administrator, and anyone else who works on the school campus (including, e.g. food vendors, medical service providers, lawn maintenance staff). Physical badges are prepared and laminated. Data entry is confirmed with the database of the access control system and is backed up to data repository 203 as required. The group implementation project 313 and specifically the badging process is tracked by project management application 186e to insure that all steps are accomplished before releasing a badge.

An alternate process of badging is required for new employees and students at step 912. During this process of badging, every new employee of the school district and new student undergoes an extensive screening process. An optional criminal record check occurs at step 913. If consent is required it is obtained in this step. A citizenship check occurs at step 914, a social security number check occurs at step 916, a motor vehicle report check occurs at step 918 and a credit report check occurs at step 920. Fingerprints are taken at step 922 and photographs at step 924. Badges for the new students and employees are created in step 926. Physical badges are prepared and laminated. For the alternate badging process, data entry is confirmed with the badge holder database 114 of the access control system and is backed up to data repository 203 as required. The group implementation project 313 and specifically the badging process are tracked by project management application 186e to insure that all steps are accomplished before releasing a badge.

Referring to FIG. 3, training step 315 follows badging step 314. In step 315, training of teachers and staff with respect to recognition of physical traits and benchmark characteristics that indicate potential school-based violence and disruptive behavior is instituted.

The behavioral training program is designed to help faculty identify a violent threat before it manifests itself. The training provides guidelines to faculty and employees as to intervention timing and methods. The training further educates faculty and employees as to existing government behavioral security requirements. A legal liaison is provided to train the faculty and employees as to school district and personal liability, racial concerns and local and state laws. Self defense and martial arts training is also provided. Weapons and explosive ordinance training is conducted at this step in the preferred embodiment.

The training includes direct staff training in classroom management, de-escalation, stress management, and other critical issues related to initiating and sustaining effective, supportive teacher-student interaction. The training further includes guiding assessment staff, administrators, and campus teams through behavior management issues in a “response to intervention model”, including instruction as to research-based interventions, multi-tiered models, universal screening, and “data based” decision making. Also included in the training is how to identify and implement effective conflict resolution programs, “no-bullying” programs, and threat assessment procedures.

Training is facilitated by the assignment of trainers, equipment and the tracking of software usage according to the project management application 186e and training application 186f. Training application 186f facilitates web-based training online and may track the passing or failure of online testing related to the training.

Referring again to FIG. 3, step 324 is user acceptance testing. User acceptance testing is a process to obtain confirmation by the school district that the installed security system meets the requirements and expectations of the department contact. User acceptance testing is a final verification of the required proper functioning of the security system, emulating real world usage conditions. In this step, network loading is balanced and final network architecture changes are accomplished.

Still referring to FIG. 3, after user acceptance testing step 324 and training step 315 are complete, the comprehensive security program is operable and monitoring step 326 begins. At step 326, the access control system is operationally activated. The tasks of monitoring the schools via live guards, monitoring center 158, video cameras, audio sensors, etc. and responding to alarms are performed. Monitoring step 326 also includes the step of logging trends in behaviors and alerting school staff of possible future threats recognized from the trends. As an example, a certain group of students consistently congregating in a certain place at a certain time is logged as an anomaly. As another example an unusual traffic pattern may arise in student traffic or vehicle traffic indicating an emergency or panic situation. A guard or faculty member is alerted to the situation by e-mail and by text message to a cell phone or PDA. Further, state or local authorities may also be alerted automatically to the anomaly, if required. In the preferred embodiment, the step of monitoring also includes monitoring of the access control system remotely through a wide area network or the Internet by the security system provider.

Step 328 of FIG. 3 includes the assumption and management of the scalable administration services outsourced by the security provider to generate cost savings and ultimately fund the security program deployment.

Step 330 of FIG. 3 occurs after a predetermined period of time. The step in one preferred embodiment is typically scheduled to occur after about three to five years of operation of the access control system. Step 330 involves auditing the functions of the access control system and addressing technical issues discovered. Step 330 also includes continuing education of the faculty and administrators on behavioral management. Additionally, step 330 may include the installation of additional or upgraded security equipment. Additionally, step 330 may include the generation of a security benchmark success report. The security benchmark success report requires an audit of the incidence rate parameters identified and cataloged in the site survey. The new incidence rates are compared to the incidence rates taken in the site survey to arrive at an objective indication of “success” or “failure” of the security system.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. A computer network for assessing, financing, deploying and monitoring, a set of security systems in a set of campuses, each campus having a security system of the set of security systems connected to the computer network, comprising:
An application server communicatively connected by the internet to the set of security systems;
The application server communicatively connected to a first data repository;
A set of computer applications operating on the application server and designed to support a set of functions;
The set of functions comprising: assessment, financing, deployment, and operations of the set of security systems;
A wide area network controller for the computer network, communicatively connected to the set of security systems, a second data repository, and a monitoring center controller;
The monitoring center controller communicatively connected to the set of security systems;
A first computer located on at least one campus for performing a site survey, the first computer communicatively connected to the application server;
The site survey consisting of a set of locations for the placement of security system components and an audit of scaleable functions;
A second computer located on at least one campus for performing site verification and inventory, the second computer communicatively connected to the application server;
A third computer communicatively connected to the application server;
The third computer operating a program which exchanges information with the set of computer applications on the application server;
Wherein the set of locations from the site survey in the first computer is used by the accessing application operating on the application server to determine a set of requirements for each security system in the set of security systems;
The requirements consisting of a set of security system components and security personnel;
The financing application operating on the application server compares the requirements of the set of security systems with cost savings based on the audit of scalable administrative functions from the site survey, creating for each security system in the set of security systems a range of security system protection versus cost, enabling negotiation of a final contract;
The deployment application operating on the application server uses the requirements of the set of security systems and the final contract to specify the set of security components for each security system in the set of security systems, communication with the second computer allows the application to perform site verification and inventory functions for the security system components for each security system as the components arrive; and,
The monitoring center overseeing the operation of the set of security systems.

2. The computer network of claim 1 further comprising a badging system communicatively connected to the computer network.

3. The computer network of claim 1 further comprising a set of external security resources communicatively connected to the computer network.

4. A method for assessing, financing, deploying and operating a set of security systems for a set of campuses, the method including the steps of:
Performing a site survey on each campus in the set of campuses to gather a first set of site survey data which includes at least a first set of locations, each location of the set of locations having a first set of security system components;
Sending the first set of site survey data to an application server;
Performing a first engineering analysis based on the first set of site survey data, further having the steps of:
a) creating a first computer model for each security system in the set of security systems;
b) deriving a first bill of materials required for each security system in the set of security systems;
Using a first computer application residing on the application server to finalize a deployment contract for the set of security systems based on a total from all first bills of material, thereby producing a final contract document that specifies the set of security system components for each security system of the set of security systems for each campus in the set of campuses;
Initiating a first project to physically implement a security system of the set of security systems at a campus of the set of campuses;
The first project being tracked using a second computer application residing on the application server;
Initiating a second project to educate a set of personnel on each campus of the set of campuses;
The second project being tracked using a third computer application residing on the application server;
Monitoring the set of security systems using a wide area network controller.

5. The method of claim 4 including the step of outsourcing an administration function from at least one campus in the set of campuses.

6. The method of claim 4 including the step of periodically assessing each security system in the set of security systems for a set of new security system components.

7. The method of claim 4 wherein the step of initiating a second project includes the further steps of badging the set of personnel and training the set of personnel.

8. The method of claim 7 where the step of finalizing the deployment contract further including the steps of:
a) Creating a set of funding option templates;
b) Storing the funding option templates in a financial assessment computer application, on the application server;
c) Operating the financial assessment computer application to evaluate a first funding option using a first funding option template of the set of funding option templates;
d) Creating a cost savings report associated with the first funding option;
e) Negotiating a deployment contract, associated with the cost savings report;
f) Gaining approval of the deployment contract;
g) Creating the final contract document which is associated to the approved deployment contract;
h) Storing the final contract document in a first data repository.

9. The method of claim 7 where the badging step further including the steps of:
Managing a badging process for each campus of a set of campuses using a project management computer application residing on the application server;
The badging process comprising the steps of:
a) Utilizing a set of external security resources to verify information required in the following steps of the badging process;
b) For each person currently approved for access to the security system of the set of security systems repeating the steps of:
i) Evaluating a criminal history of the person;
ii) Creating a photograph of the person;
iii) Taking a fingerprint of the person;
iv) Storing the data in the previous steps, which is associated to the person, in a second data repository or a badge holder database of an access control system of a security system of the set of security systems;
v) Creating a security badge for the person.

10. The method of claim 4 wherein the additional step of badging a set of engineering and installation personnel is completed prior to the step of initiating the first project.

11. The method of claim 4 including the step of performing a second engineering analysis for each security system in the set of security systems, having the steps of:
Using the final contract document to specify a set of security system design modules;
Using the final contract document to specify a set of security system custom modules;
Creating a second computer model from the set of security system design modules and from the set of security system custom modules and from the first computer model;
Deriving a second bill of materials for at least one security system of the set of security systems;

12. The method of claim 4 wherein the step of performing a site survey includes the additional steps of:
For each campus in the set of campuses, the steps of:
a) Storing the first set of site survey data in a first data repository communicatively connected to the application server;
b) Assessing a current level of campus security provided to create a second set of site survey data;
c) Storing the second set of site survey data in the first data repository;
d) Performing an administrative audit for the campus from the set of campuses;
e) Performing a risk assessment for the campus from the set of campuses;
f) Creating a risk report from the risk assessment;
g) Creating a list of security vulnerabilities from the risk report;
h) Performing a financial assessment using a fourth computer application residing on the application server;
i) Creating a cost savings report for outsourcing administrative functions from the administrative audit;
j) Producing a site survey report that includes at least a second set of locations requiring a second set of security system components from at least one of the group of the first set of site survey data, the second set of site survey data, the risk report, the list of security vulnerabilities, and the cost savings report;
k) Storing the site survey report in the first data repository.

13. The method of claim 12 wherein the step of performing the first engineering analysis includes the additional steps of:
a) Creating a collection of standard locations requiring security;
b) Creating a collection of security system design modules;
c) Correlating each design module of the collection of security system design modules to a standard location in the collection of standard locations;
d) Each design module of the collection of security system design modules specifying a list of security system components required to build the design module;
e) For each location of the set of locations contained in the site survey report, the steps of:
i. Choosing a first selected location;
ii. Comparing the first selected location the collection of standard locations, resulting in a first standard location;
iii. Choosing a first security system design module from the collection of security system design modules correlated to the first standard location; and
iv. The first security system design module specifying a list of security system components required for the first selected location.

14. The method of claim 4 including a system assembly and shipment process implemented prior to the completion of the first project, comprising of the steps of:
a) Managing the following steps of the system assembly and shipment process using a project management computer application residing on the application server;
b) Organizing security system components into a set of design modules, each design module of the set of design modules corresponding to a predefined location on a campus of the set of campuses;
c) Palletizing a set of design modules from the set of design modules for each security system of the set of security systems to create a set of palletized design modules;
d) Coordinating a shipment of the set of palletized design modules to the set of campuses;
e) Deploying a set of installation teams to the set of campuses;
f) Shipping the set of palleteized design modules to each campus of the set of campuses;
g) Having a pre-installation meeting including at least one installation team at each campus of the set of campuses.

15. The method of claim 4 wherein the first project includes a system installation process comprised of the steps of:
Managing the following steps of the system installation process for each campus of the set of campuses using a project management computer application of the set of applications residing on the application server;
a) Shipping the first set of security system components to each campus;
b) Verifying the first set of security system components at the campus;
c) Installing the first set of security system components;
d) Activating an external data line to communicate with the wide area network controller; and,
e) Performing a security system diagnostic process.

16. The method of claim 4 where the first project includes site verification for each campus in the set of campuses, which is further comprised of the steps of:
Verifying the first set of security system components at each campus of the set of campuses;
Initializing a fourth computer application residing on the application server to log the first set of security system components as inventory data;
Storing the inventory data in a first data repository.

17. The method of claim 4 including the step of activation of each security system of the set of security systems.

18. The method of claim 4 including the additional step of user acceptance testing.

19. The method of claim 4 where the badging step further including the steps of:
Managing a badging process for each campus of the set of campuses using a project management computer application residing on the application server;
The badging process comprising the steps of:
a) Utilizing a set of external security resources to verify information required in the following steps of the badging process;
b) For each new person who has not been previously approved for access to the security system of the set of security systems, repeating the steps of:
i) Performing a criminal record check for the new person;
ii) Performing a citizenship check for the new person;
iii) Performing a social security number check for the new person;
iv) Obtaining a motor vehicle report for the new person;
v) Obtaining a credit report for the new person;
vi) Taking a fingerprint of the new person;
vii) Taking a photograph of the new person;
viii) Storing the data in the previous steps, which is associated to the person, in a second data repository or in a badge holder database of an access control system of a security system of the set of security systems;
ix) Creating a security badge for the new person.
